(19) United States
(12) Patent Application Publication
(10) Pub. No.: US 2011/0077830 A1
(43) Pub. Date: Mar. 31, 2011

(54) METHOD AND APPARATUS FOR NEUTRAL IDLE CLUTCH CONTROL IN A VEHICLE HAVING AN ENGINE START-STOP POWERTRAIN

(75) Inventors: Ronald F. Lochocki, JR., Ypsilanti, MI (US); David W. Wright, Howell, MI (US); Micheal P. Portell, San Antonio, TX (US)

(73) Assignee: GM GLOBAL TECHNOLOGY OPERATIONS, INC., Detroit, MI (US)

(21) Appl. No.: 12/567,888

(22) Filed: Sep. 28, 2009

(51) Int. Cl. G06F 19/00

(52) U.S. Cl. 701/68

(57) ABSTRACT

A method and apparatus provide control of a neutral idle (NI) clutch to allow a vehicle with automatic engine start-stop functionality to utilize the NI state as a transitional shift state, either upon or just prior to engine shutdown, to minimize driveline disturbances. By controlling the NI state, the vehicle driveline is decoupled and torque multiplication is prevented upon engine restart. Execution of an algorithm unloads the engine upon shutdown, and unloads or partially loads the engine as a designated NI clutch reapplies during an engine restart event. The NI clutch may be a component of a multi-speed automatic transmission, e.g., a 6-speed or an 8-speed transmission, having a plurality of torque transfer mechanisms or clutches. One of these clutches is designated as the NI clutch, and this designated NI clutch may be selectively actuated to enter the NI state in conjunction with engine shut down/restart.

### TECHNICAL FIELD

The present invention relates to the shift control of a transmission having neutral idle functionality in a vehicle having an engine start-stop powertrain.

### BACKGROUND OF THE INVENTION

Vehicle transmissions are designed to transmit torque from an engine to a set of drive wheels in order to propel the vehicle in a range of output speeds. The engine output shaft may be selectively connected to a transmission input shaft when engine propulsion is required. In a manual transmission, a clutch pedal may be depressed to allow a driver to shift gears and/or to place the transmission into a neutral state. In an automatic transmission, a hydrodynamic torque converter automatically provides this engine/transmission connection.

A torque converter includes an impeller/pump, a turbine, and a stator. The torque converter is filled with oil. The pump, which may be bolted to a rotating engine flywheel to continuously rotate at engine speed, discharges the oil into the turbine. The turbine is connected to the transmission input shaft, and therefore rotation of the turbine ultimately causes a rotation of the coupled transmission input shaft. A stator redirects oil discharged from the turbine back into the pump. The use of a torque converter thus enables a variable fluid coupling effect to automatically occur between the engine and the transmission, thereby allowing the vehicle to slow to a stop without stalling, while also allowing required torque multiplication to occur at low vehicle output speeds.

This variable slip capability allows the engine to continue to rotate when the vehicle is idling in certain transmission states or modes, e.g., in park (P), neutral (N), or in a drive state, i.e., a forward drive mode (D) or a reverse mode (R). In some transmission designs operating in a neutral (N) state during a drive detent position, i.e., when the vehicle reaches zero output speed at a standstill or when idling and the engine remains running, the transmission may be automatically shifted to a hydraulic neutral state referred to as neutral idle (NI).

Certain vehicle powertrains such as hybrid electric vehicle (HEV) powertrains are able to selectively utilize different energy sources to optimize fuel efficiency. An HEV having a full hybrid powertrain can use either or both of an internal combustion engine and a high-voltage energy storage system (ESS) for propulsion. That is, a typical full HEV powertrain can be electrically-propelled immediately upon starting the HEV and during vehicle speeds up to a relatively low threshold speed. One or more high-voltage motor/generator units (MGU) may alternately draw power from and deliver power to the ESS as needed. Above the threshold speed, the engine can be restarted and engaged with the transmission to provide the required propulsive torque.

The powertrain of a mild HEV lacks the capability of propelling the HEV via purely electrical means, but nevertheless retains certain key design features of the full hybrid powertrain, e.g., the capability of selectively shutting down or powering off the engine at idle. The capability of any HEV to selectively shut off and restart its engine when the vehicle is at a standstill, and/or when operating in a stabilized low-speed drive mode, is of particular fuel-saving benefit relative to conventional vehicle designs.

### SUMMARY OF THE INVENTION

Accordingly, a method and apparatus are provided herein for controlling a neutral idle (NI) clutch shift operation to allow a vehicle with automatic engine start-stop functionality to utilize the NI state as a transitional shift state. By using the NI state as a transitional shift state, either upon or prior to engine shutdown as well as upon restart of the engine, the vehicle driveline is decoupled to minimize driveline disturbances, and torque multiplication may be prevented upon engine restart. Shutting down an engine reduces fuel consumption, as noted above, however doing so may result in a temporary loss of oil pressure to the various clutches and gears of a transmission gear box. Some amount of oil pressure is required for optimal transmission control upon engine restart and vehicle launch, and therefore an auxiliary device, e.g., an auxiliary pump or a surge accumulator, may be used for this purpose without departing from the intended scope of the invention.

Maintaining oil pressure with an auxiliary device allows the transmission to remain in 1^{st} gear in a conventional powertrain. However, a starter motor must crank against a stationary turbine and a locked gearbox, a situation which may produce cranking and combustion-related torsional transients along the driveline during engine restart. The present method and apparatus therefore enable the engine to shut down and restart in an unloaded or a partially-loaded state as set forth herein, depending on the particular auxiliary device that is used.

Execution of the algorithm embodying the method by an onboard controller unloads the engine upon shutdown, and unloads or partially loads the engine as a designated NI clutch reapplies during an engine restart event. The vehicle includes a multi-speed automatic transmission, e.g., a 6-speed or an 8-speed transmission of the type disclosed herein, having a plurality of torque transfer mechanisms or clutches. One of these clutches may be designated as the NI clutch. This designated NI clutch may be selectively actuated to enter the NI state, and may also be used to launch the vehicle in 1^{st} gear.

As the NI state is entered, the unloaded engine shuts down. The algorithm commands a clutch pressure, which is either zero or a pre-learned return spring pressure depending on the particular oil-assist type or auxiliary device, if used, e.g., an auxiliary pump, a surge accumulator. Upon engine restart, the NI clutch may be held at a pre-learned return spring pressure or commanded via a fill pulse, again depending on the oil-assist type. Clutch reapply for vehicle launch begins at a predetermined point in the engine restart event. As the vehicle begins to move during launch, reapply of the NI clutch, which is also configured as the 1^{st} gear clutch, continues until the NI clutch is locked and the vehicle moves. When a partially-loaded state is used, the NI clutch may begin slipping and pulling down turbine speed earlier in the process.

In particular, a vehicle is provided that includes an engine, a plurality of clutches that are selectively engageable, alone or in combination with each other, to establish a plurality of forward drive modes, with one of these clutches being designated as the NI clutch. The engine is adapted to shut down at idle or when the vehicle is stationary to conserve idle fuel consumption. A controller includes an algorithm adapted for shifting the transmission into the NI state to at least partially unload the engine prior to the engine shut down and during the subsequent restart maneuver.

A method is also provided for shifting a transmission of a vehicle into the NI state during an engine shut down and restart event, the transmission having a plurality of clutches that are selectively engageable, alone or in combination with each other, to establish a plurality of forward drive modes. The method includes determining the presence of a commanded engine shut down event using a controller, actuating a designated one of the clutches as an NI clutch using the controller to thereby enter the NI state prior to shutting down the engine to thereby at least partially unload the engine, and determining the presence of a commanded engine restart event using the controller. The method also includes starting the engine while the engine remains at least partially unloaded, and then actuating the NI clutch to thereby launch the vehicle.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a vehicle having an automatic transmission, engine start-stop functionality, and a neutral idle (NI) clutch shift control method or algorithm in accordance with the invention;

FIG. 2A is a lever diagram for one embodiment of a transmission usable with the vehicle shown in FIG. 1;

FIG. 2B is a lever diagram for another embodiment of a transmission usable with the vehicle shown in FIG. 1;

FIG. 2C is a lever diagram for yet another embodiment of a transmission usable with the vehicle shown in FIG. 1;

FIG. 3 is a graphical flow chart describing an algorithm suitable for executing the NI clutch shift control method of the invention; and

FIG. 4 is a set of vehicle performance curves describing an NI clutch shift operation during engine start-stop cycling.

### DESCRIPTION OF THE PREFERRED EMBODIMENTS

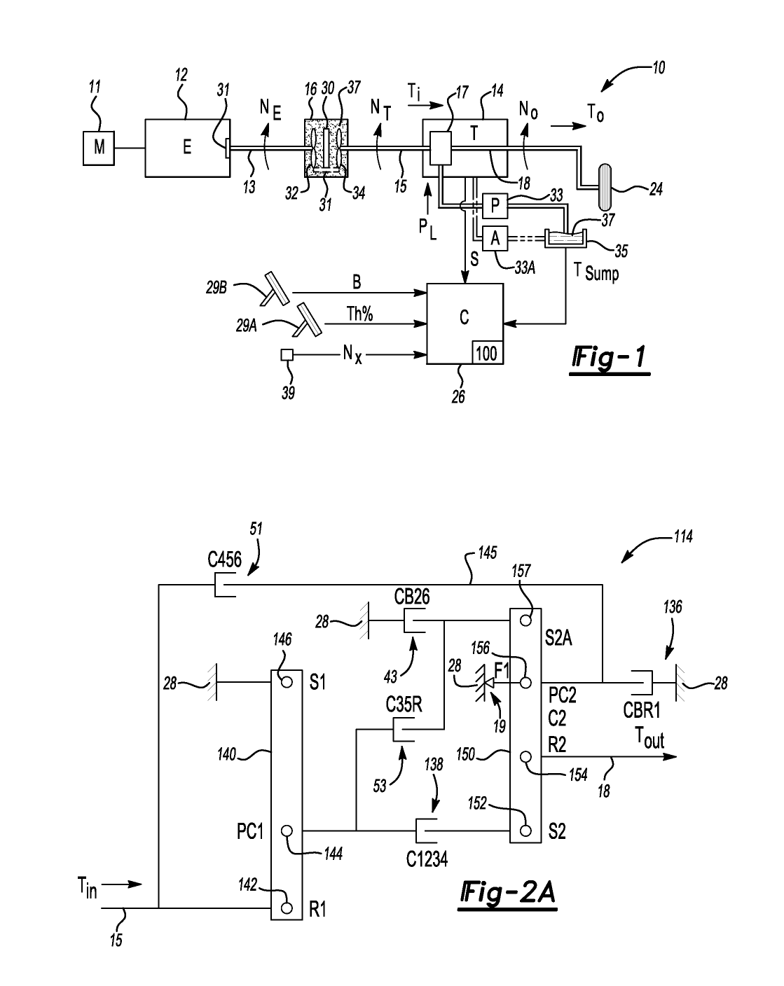

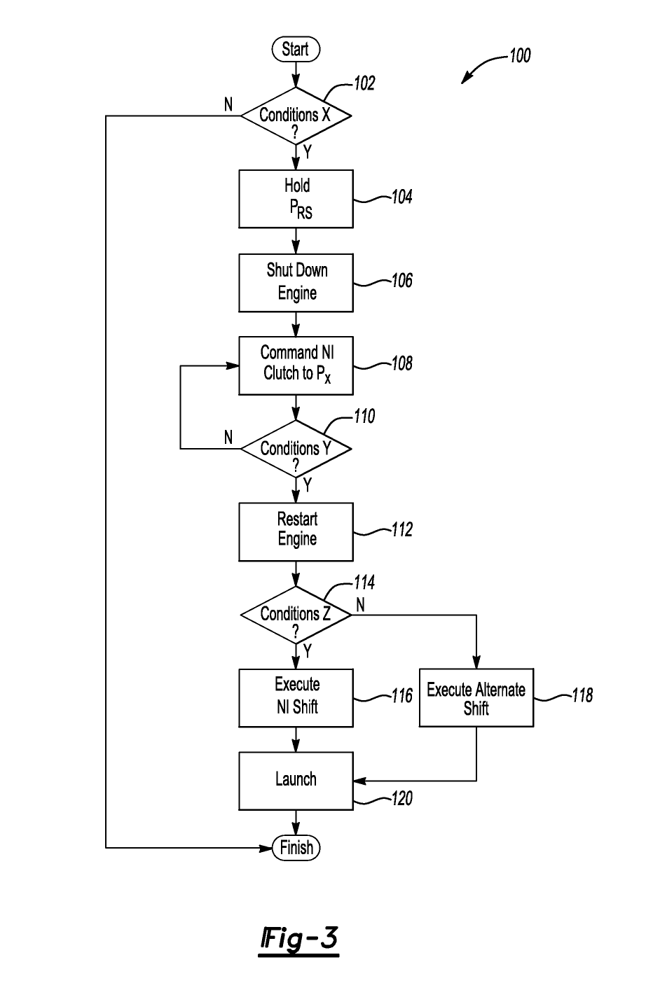

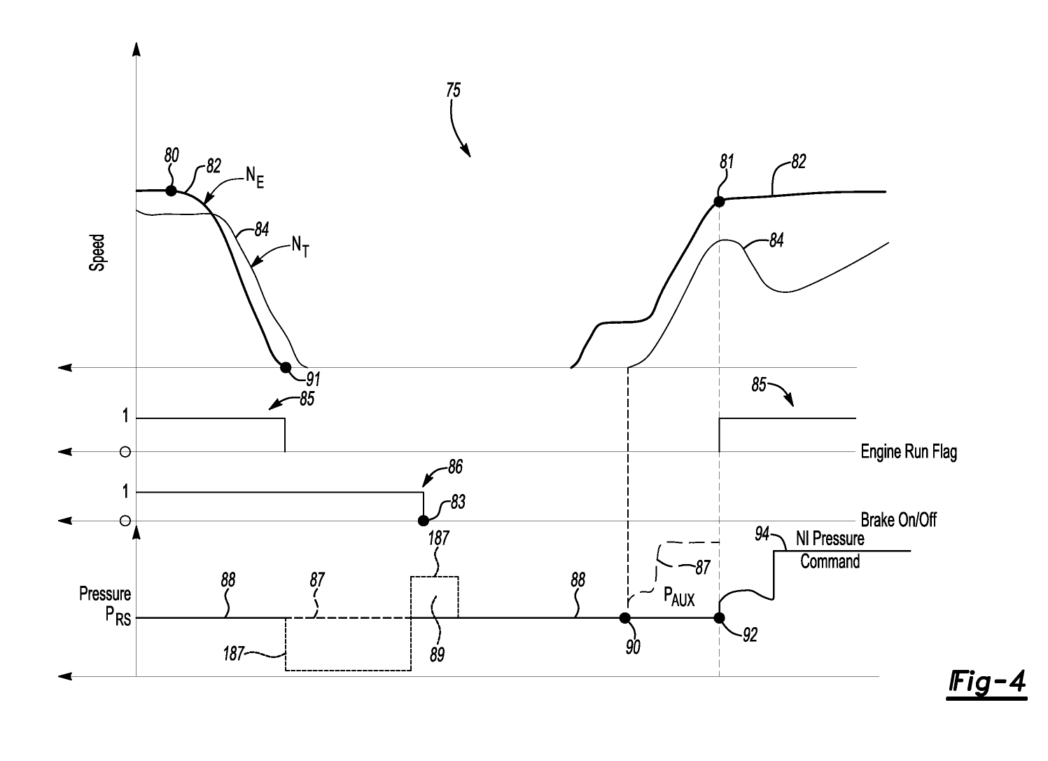

Referring to the drawings, wherein like reference numbers correspond to like or similar components throughout the several figures, the vehicle 10 shown in FIG. 1 includes a controller (C) 26 having a neutral idle (NI) shift control algorithm 100, as described below with reference to FIGS. 3 and 4. The controller 26 is adapted for executing the algorithm 100 to thereby control an NI shift event in conjunction with an engine shut down/restart or start-stop event. The NI state may be entered either during a coast-down maneuver from a forward drive mode while the vehicle 10 is still moving, or once the vehicle reaches a zero speed. Execution of algorithm 100 allows an engine (E) 12 to shut down and restart in a partially-loaded or a fully unloaded state, by controlling the shift operation of a designated NI clutch, assisted by the particular onboard oil-assist type described below.

The engine 12 is controlled to provide start-stop functionality, also known as autostop/autostart capability, wherein the engine is selectively turned off at idle or at zero speed to conserve fuel as noted above. A starter motor 11 may be used to crank and restart the engine 12. The engine 12 is selectively coupled to an automatic transmission (T) 14 via a hydrodynamic torque converter 16. An output shaft 13 of the engine 12 rotates at an engine speed (N_{E}), and an input shaft 15 of the transmission 14 rotates at a turbine speed (N_{T}). Transfer of an input torque (Tᵢ) to the transmission 14 thus occurs at a variable rate through the torque converter 16.

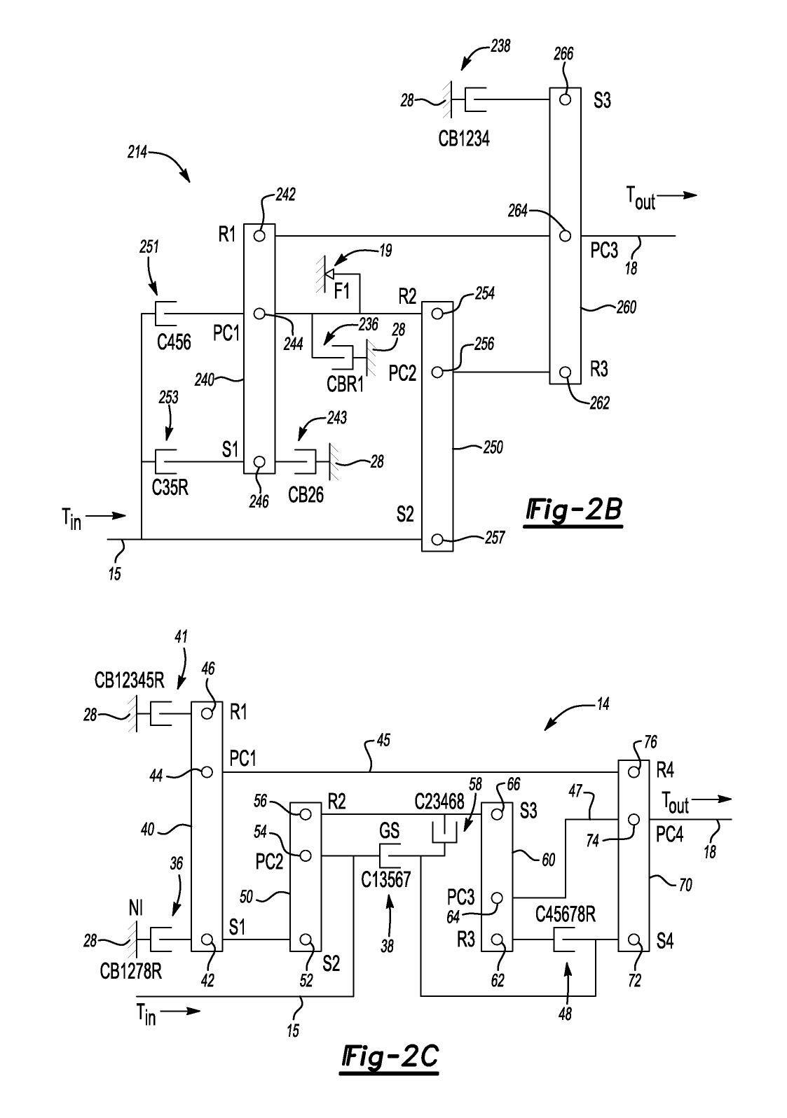

The transmission 14 also includes an output shaft 18 connected to a set of road wheels 24. The output shaft 18 ultimately carries a transmission output torque (Tₒ) from various clutch and gear sets 17 of the transmission 14, including a designated NI clutch as noted below with reference to FIGS. 2A-C, to thereby propel the vehicle 10. A differential (not shown) may be included in the design without departing from the intended scope of the invention.

The clutch and gear sets 17 may be selectively actuated using electro-hydraulic controls powered by fluid from a main transmission pump (P) 33 at a line pressure (P_{L}). The pump 33 may be configured to draw fluid 37 from a sump 35, with the fluid having a temperature (T_{Sump}). However, other non-fluidic actuating means or devices may also be used within the scope of the invention. Additionally, an optional auxiliary device (AUX) 33A, e.g., an electrically-operated auxiliary fluid pump or a surge accumulator adapted for temporarily directing oil to the clutch and gear sets 17 when the engine 12 is restarted, may be used to ensure delivery of sufficient oil pressure to the transmission 14 during an engine-off state and upon engine restart.

Still referring to FIG. 1, the transmission 14 may be configured as a multi-speed transmission, e.g., a 6-speed or an 8-speed transmission of the type set forth in FIGS. 2A-2C below, having NI state functionality. Transmission 14 has a designated NI clutch that can be automatically actuated to establish the NI state during a coast-down maneuver from a forward drive mode while the vehicle 10 is still moving, i.e., 1^{st} gear or a higher forward drive gear, or upon the vehicle 10 reaching a zero speed, depending on the configuration of the vehicle.

In a neutral idle (NI) state, the transmission 14 may be placed in a drive (D) mode while electro-hydraulic clutch pressure regulation valves (not shown) reduce the pressure on a designated NI clutch, thereby placing the transmission into a partially-loaded “hydraulic neutral” state as noted above. Data used by the algorithm 100 may reside within or may be accessible by the controller 26, and may be sampled or processed thereby during other transmission states such as neutral (N) and park (P).

Vehicle data that may be sampled in order to determine appropriate NI state entry conditions may include, but are not necessarily limited to: vehicle output speed (N_{O}), a value which may be measured by one or more sensors 39 shown separately in FIG. 1 for clarity, but which could also be positioned as needed within the vehicle 10, e.g., at or along the transmission output shaft 18 and/or at the road wheels 24, etc; a throttle level (Th %) of a throttle input device such as an exemplary accelerator pedal 29A; a braking level (B) such as pedal position/travel and/or a braking force applied to brake pedal 29B; a PRNDL setting (S) of the transmission 14; a temperature (T_{Sump}) of the fluid 37 contained in or delivered from the sump 35; onboard diagnostics; etc.

Still referring to FIG. 1, the engine 12 and torque converter 16 are in communication with the controller 26, which is configured for storing and accessing the algorithm 100. The algorithm 100 in turn is specially adapted to execute the method of the invention as described below with reference to FIGS. 3 and 4. The controller 26 may be configured as a microprocessor-based device having such common elements as a microprocessor or CPU, memory including but not limited to: read only memory (ROM), random access memory (RAM), electrically-erasable programmable read-only memory (EEPROM), etc., and circuitry including but not limited to: a high-speed clock (not shown), analog-to-digital (A/D) circuitry, digital-to-analog (D/A) circuitry, a digital signal processor or DSP, and the necessary input/output (I/O) devices and other signal conditioning and/or buffer circuitry. However configured, the controller 26 is operable for executing at least the algorithm 100 of FIG. 3 as needed to provide entry in an NI state during a coast-down maneuver from a forward drive mode.

The controller 26 is adapted for receiving, reading and/or measuring, calculating, and recording or storing various required measurements, values, or figures including any required readings fully describing the engine speed (N_{E}), turbine speed (N_{T}), and the transmission output speed (N_{O}), such as via one or more speed sensors 39 having an output speed or speeds labeled generically as (N_{X}). The speed signals (N_{E}), (N_{O}) may be transmitted electrically via conductive wiring, although other transmitting means are also usable within the scope of the invention, for example radio frequency (RF) transmitters and receivers.

The torque converter 16 includes a stator 30 between an impeller or pump 32 and a turbine 34. An optional lockup torque converter clutch (TCC) 31 may also be used to selectively lock the pump 32 and turbine 34 above a threshold lockup speed. The pump 32 may be bolted or otherwise directly connected to the output shaft 13 to thereby rotate at engine speed (N_{E}). Within the torque converter 16, the turbine 34 is driven by fluid 37 and is connected to the input shaft 15 of transmission 14. Thus, a rotation of turbine 34 ultimately rotates the input shaft 15 at a turbine speed (N_{T}) less than or equal to engine speed (N_{E}). Viscous drag or friction losses occurring within the transmission 14 may reduce the turbine speed (N_{T}) to a level slightly less than engine speed (N_{E}) as shown in FIG. 4, and as understood by those of ordinary skill in the art.

Referring to FIG. 2A, the transmission 14 of FIG. 1 is shown as a transmission 114 configured as a 6-speed front wheel drive transmission, which may be adapted for use as either a rear wheel drive (RWD) or a front wheel drive (FWD) transmission. Transmission 114 may include first and second gear sets 140 and 150, respectively; braking clutches CB26, i.e., clutch 43, and CBR1, i.e., clutch 136; and rotating clutches C35R, i.e., clutch 53, and C1234, i.e., clutch 138.

In the 6-speed embodiment of FIG. 2A, either of the following clutches noted above may be used as the designated NI clutch noted above in order to enter neutral idle (NI) from a forward drive mode or from a standstill: clutch CBR1, i.e., clutch 136, and clutch C1234, i.e., clutch 138. For clutch 136, the NI state may be entered from as high as 1st gear; for clutch 138, from as high as 4^{th} gear. When using clutch 138, a free-wheeling element (F1) 19 is used to prevent rotation with respect to node 156 of the second gear set 150.

The first gear set 140 may include nodes 142, 144, and 146, which in one possible embodiment may be a ring gear (R1), a carrier member (PC1), and a sun gear (S1), respectively. The input shaft 15 may be directly connected to node 142, and to an input side of clutch C456, i.e., clutch 51. Node 144 may be connected to an input side of clutch C1234, i.e., clutch 138, and to an input side of clutch C35R, i.e., clutch 53. Node 146 is grounded to the stationary member 28. As will be understood by those of ordinary skill in the art, as used in FIGS. 2A-C the term C1234, for example, refers to a clutch (C) used to establish each of 1ₛₜ, 2^{nd},3^{rd}, and 4^{th} gear, i.e., the various forward drive modes that a clutch so labeled may be used to establish. Likewise, use of the letters B or R in the same clutch designation refers to a braking clutch and reverse gear, respectively.

Second gear set 150 includes nodes 152, 154, 156, and 157, which may be respectively embodied as a sun gear (S2), a ring gear (R2), a carrier gear (PC2), and another sun gear (s2A), respectively. Node 154 is directly connected to the transmission output shaft 18 and rotates at output speed (Tₒᵤₜ). Node 156 is connected to an input side of clutch CBR1, i.e., clutch 136, which is also connected to stationary member 28.

As noted above, either of clutches 136 and 138 may be utilized as the designated NI clutch without departing from the intended scope of the invention. When using clutch 138, an optional free-wheeling mechanism (F1) 19 may be connected between stationary member 28 and node 156 to allow rotation with respect to node 156 in only one rotational direction. When using clutch 136 as the NI clutch, the free-wheeling mechanism 19 may be omitted.

Referring to FIG. 2B, the transmission 14 of FIG. 1 is shown as a transmission 214 configured as another 6-speed front wheel drive transmission, which like the transmission of FIG. 2A may also be adapted for use as either a rear wheel drive (RWD) or a front wheel drive (FWD) transmission. Transmission 214 may include first, second, and third gear sets 240, 250, and 260, respectively; braking clutches CB26, i.e., clutch 243, CBR1, i.e., clutch 236, and CB1234, i.e., clutch 238; and rotating clutches C35R, i.e., clutch 253, and C456, i.e., clutch 251.

In the 6-speed embodiment of FIG. 2B, clutch CB1234, i.e., clutch 238, may be used to enter neutral idle (NI) from a standstill or from a forward drive mode. When using clutch 238, the free-wheeling element (F1) 19 may be used to prevent rotation with respect to node 254 of the second gear set 250.

First gear set 240 may include nodes 242, 244, and 246, which in one possible embodiment may be a ring gear (R1), a carrier gear (PC1), and a sun gear (S1), respectively. The input shaft 15 may be selectively connected to nodes 244 and 246 via clutches 251 and 253, respectively. Node 242 is directly connected to node 264 of the third gear set 260.

Second gear set 250 includes nodes 254, 256, and 257, which in one possible embodiment may be configured as a ring gear (R2), a carrier gear (PC2), and a sun gear (S2), respectively. Node 257 is directly connected to the transmission input shaft 15. Node 254 is connected to node 244 of the first gear set 240. Free-wheeling element (F1) 19 connects to stationary member 28 to allow rotation with respect to node 254 in only one rotational direction.

Third gear set 260 includes nodes 262, 264, and 266, which may be embodied as a ring gear (R3), a carrier gear (PC3), and a sun gear (S3), respectively. Node 266 is selectively connected to stationary member 28 via a clutch CB1234, i.e., clutch 238. Node 264 is connected to node 242 of the first gear set 240, and to the output shaft 18 of transmission 14. Node 262 is directly connected to node 256 of the second gear set 250.

Clutch 238, i.e., CB1234, may be utilized as the NI clutch in this particular embodiment as noted above. When using clutch 238, free-wheeling mechanism (F1) 19 may be connected between nodes 244 and 254 of gear sets 240 and 250, respectively, to allow rotation with respect to node 254 in only one rotational direction. Clutch 236, i.e., CBR1 can be used as the NI clutch if F1 is omitted.

Referring to FIG. 2C, in yet another embodiment the transmission 14 shown in FIG. 1 may be configured as an 8-speed transmission, either FWD or RWD, having a plurality of gear sets and clutches, i.e., the clutches and gears 17 of FIG. 1. Transmission 14 may include a first, second, third, and fourth gear sets 40, 50, 60, and 70, braking clutches CB12345R, i.e., clutch 41, and CB1278R, i.e., clutch 36; and rotating clutches C13567, i.e., clutch 38, C23468, i.e., clutch 58, and C45678R, i.e., clutch 48.

In the 8-speed embodiment of FIG. 2C, any of the following clutches noted above may be used to enter neutral idle (NI) from a standstill or from a forward drive mode: clutch CB1278R, i.e., clutch 36; braking clutch CB12345R, i.e., clutch 41; and clutch C13567, i.e., clutch 38. For clutch 36, the NI state may be entered from as high as 2^{nd} gear; for clutch 41, as high as 5^{th} gear; and for clutch 38, as high as 1^{st} gear.

The first gear set 40 may include nodes 42, 44, and 46, which may be a sun gear (S1), a carrier (PC1), and a ring gear (R1), respectively. Node 46 maybe selectively connected to stationary member 28 via a clutch CB12345R, i.e., clutch 41. Node 42 may be selectively connected to stationary member 28 via a clutch CB1278R, i.e., clutch 36. Node 42 is also connected to a node 52 of second gear set 50. Node 54 of gear set 50 is connected to an input side of a rotating clutch C13567, i.e., clutch 38, as is the transmission input shaft 15 with input torque (Tᵢₙ). Node 56 is connected to a third gear set 60 as explained below.

The second gear set 50 may include nodes 52, 54, and 56, which may be a sun gear (S2), carrier (PC2), and ring gear (R2), respectively. Node 52 maybe directly connected to node 42 of gear set 40. Node 54 may be directly connected to the transmission input shaft 15.

The third gear set 60 may include nodes 62, 64, and 66, which may be a sun gear (S3), carrier (PC3), and ring gear (R3), respectively. Node 66 may be directly connected to node 56 of the second gear set 50, and selectively connected to node 54 by a clutch C23468, i.e., clutch 58, and a clutch C13567, i.e., clutch 38.

The fourth gear set 70 may include nodes 72, 74, and 76, which may be a sun gear (S4), a carrier gear (PC4), and a ring gear (R4), respectively. Node 76 is directly connected to node 44 via a member 45. Node 74 is directly connected to the transmission output shaft 18, and directly connected to node 64 of the third gear set 60 via a member 47. Node 72 is selectively connected to node 62 via a clutch C45678R, i.e., clutch 48.

Referring to FIG. 3 in conjunction with the vehicle 10 of FIG. 1 and vehicle performance curves 75 of FIG. 4, the execution of the algorithm 100 utilizes the NI state in conjunction with engine on/off or start-stop cycling to minimize driveline disturbances. FIG. 4 includes traces of engine speed (N_{E})(line 82), turbine speed (N_{T})(line 84), an engine run flag 85, wherein a value of 1 represents an engine on/start state and a value of 0 represents an engine off/stop state, a brake on/off state 86, and various traces describing the different command pressures for clutch control as represented by lines 87, 88, and 94 and explained below.

Algorithm 100 begins with step 102, wherein the auxiliary system 33A, if one is used, is turned on or made ready, and wherein a set of conditions (X) is examined to determine if the engine shutdown process may proceed.

Conditions (X) may include, without being limited to, a determination that an NI state has commenced during engine shut down at approximately point 80 on the engine speed trace, i.e., line 82 of FIG. 4, that the vehicle is at a standstill at or before approximately point 91 of the same trace, the brake pedal 29B of FIG. 1 is applied as indicated by the brake on/off state, a previously-learned return spring pressure (P_{RS}) of line 88 in FIG. 4 is recorded or available, and if so equipped, that the auxiliary system 33A is on and is actively supplying oil pressure (P_{AUX})(line 87) to the clutch and gears 17, including the designated NI clutch used to enter the NI state at engine shutdown. If conditions (X) are present, the algorithm 100 proceeds to step 104, otherwise the algorithm exits.

At step 104, clutch pressure to the designated NI clutch, e.g., clutch 1234 of FIG. 2A, is held at the previously-learned return spring pressure (P_{RS}), as represented by the level of line 88 of FIG. 4, during the active NI State, and then proceeds to step 106.

At step 106, the engine 12 is automatically shut down. Engine run flag 85 may be set to zero at approximately point 91 of line 82 to indicate that engine shutdown has been completed. The brake pedal 29B of FIG. 1 is applied, as indicated by “1” state of the brake on/off state 86. The algorithm 100 proceeds to step 108.

At step 108, the algorithm 100 commands NI clutch pressure to a predetermined level, represented as P_{X} in FIG. 4. This level (P_{X}) depends on the particular oil-assist type used within the transmission 14. That is, if an auxiliary system 33A in the form of an auxiliary pump is available, it may be commanded to provide oil pressure to the designated NI clutch at a pre-learned return spring pressure (P_{RS}), i.e., line 88 of FIG. 4. If a surge accumulator is used, or if no oil-assist is provided during the engine off state, the NI clutch may be commanded to zero pressure as indicated by line 187. The algorithm 100 then proceeds to step 110.

At step 110, another set of conditions (Y) is examined to determine if a subsequent restart of the engine 12 may commence. For example, conditions (Y) may include a driver taking a foot off of the brake pedal 29B of FIG. 1, moving a PRNDL lever out of drive, making a determination of whether an onboard device requires air conditioning or heat, etc. If equipped with an optional surge accumulator, the accumulator may begin to supply oil to the designated NI clutch, as indicated by the pulse 89 of line 187 in FIG. 4. The algorithm 100 then proceeds to step 112.

At step 112, the engine 12 is cranked and started, e.g., using the starter motor 11, or using a belt alternator starter (BAS) system if so equipped. The turbine 34 of the torque converter 16 begins to rotate in conjunction with the engine output shaft 13. If equipped with a surge accumulator or no oil-assist mechanism at all other than the pump 33, a fill pulse may be optionally commanded to the designated NI clutch. Otherwise, the return spring pressure (P_{RS}) of line 88 may be commanded to begin to fill the NI clutch, which is also configured as the 1^{st} gear clutch. If equipped with an auxiliary pump, the auxiliary pump could be commanded on so that a hydraulic or other clutch control system (not shown) ultimately fed by the pump 33 may command the return spring pressure (P_{RS}) of line 88 while the engine is off, and holding the return spring pressure (P_{RS}) during engine crank, until the main pump 33 takes over. Algorithm 100 proceeds to step 114.

At step 114, another set of conditions (Z) is examined to determine if the NI clutch may be actuated. For example, conditions (Z) may include passing a calibrated engine speed threshold, or an event in which the engine run flag 85 transitions from a value of 0 to a value of 1, i.e., when engine speed reaches approximately point 81. The algorithm 100 proceeds to step 116 if conditions (Z) are satisfied, otherwise the algorithm proceeds to step 118.

At step 116, NI clutch control is executed to prevent turbine speed (N_{T}) represented by line 84 of FIG. 4 from rising beyond a calibrated range of engine speed (N_{E})(line 82). Vehicle 10 begins to launch, and the algorithm 100 proceeds to step 120.

At step 118, an alternate or default shift sequence may be executed when conditions (Z) of step 114 are not satisfied. For example, a state other than NI may be entered for launch of the vehicle 10, such as a command to maximum holding pressure resulting in a loaded start. The algorithm then proceeds to step 120.

At step 120, the designated NI clutch is commanded to full pressure, i.e., rising from the level of point 92 to a maximum holding pressure level of line 94. When using clutch C1234 of FIG. 2A as the designated NI clutch, for example, this pressure level can be used to complete a shift to 1^{st} gear, and the vehicle 10 will begin to move forward in 1^{st} gear. The algorithm 100 is then finished upon launch, with overall shift control authority thereafter provided by a top-level transmission shift control algorithm (not shown).

Accordingly, execution of the algorithm 100 using the controller 26 allows the engine 12 to shut down and restart in an unloaded or a partially loaded state by using the NI state as a transitional shift state. Execution of the algorithm 100 may provide an optimal driveline feel during engine restart and shutdown, and may provide a reduced rate of idle fuel consumption, e.g., zero when the engine 12 is off, in city driving or in other stop-and-go traffic conditions conducive to engine start-stop cycling.

While the best modes for carrying out the invention have been described in detail, those familiar with the art to which this invention relates will recognize various alternative designs and embodiments for practicing the invention within the scope of the appended claims.

1. A vehicle comprising:
an engine;
a multi-speed transmission having a plurality of clutches that are selectively engageable, alone or in combination with each other, to establish a plurality of forward drive modes, wherein one of the clutches is designated as a neutral idle (NI) clutch that is selectively actuated to shift the transmission into an NI state; and
a controller having an algorithm adapted for shifting the transmission into the NI state using the NI clutch;
wherein the engine is adapted to automatically shut down and restart during a vehicle idle condition, and wherein the controller is adapted to shift the transmission into the NI state by actuating the NI clutch prior to engine shutdown to at least partially unload the engine, and to shift the transmission out of the NI state by actuating the NI clutch after the engine is restarted.

2. The vehicle of claim 1, wherein the controller is adapted to shift the transmission into the NI state using the NI clutch during one of: a zero vehicle speed state and a coast-down maneuver of the vehicle from a forward drive mode.

3. The vehicle of claim 1, further comprising an auxiliary device adapted for maintaining a fluid pressure supplied to the transmission when the engine is off.

4. The vehicle of claim 3, wherein the controller is adapted for commanding one of a return spring pressure and a zero fill pressure to fill the NI clutch prior to engine restart depending on whether the auxiliary device is an auxiliary pump or a surge accumulator, respectively.

5. The vehicle of claim 1, further comprising a planetary gear set and a free-wheeling element, wherein the free-wheeling element is adapted for allowing rotation of a member of the planetary gear set in only one rotational direction, and wherein the NI clutch is one of the rotating clutches allowing a shift to the NI state from fourth gear.

6. The vehicle of claim 1, wherein the transmission is configured as one of a 6-speed transmission and an 8-speed transmission.

7. A controller for a vehicle having an engine adapted to be automatically shut down and restarted at a vehicle idle condition, wherein the controller is adapted to shift a multi-speed transmission of the vehicle into a neutral idle (NI) state by actuating a designated NI clutch prior to a shutdown of the engine to at least partially unload the engine, and to shift the transmission out of the NI state by actuating the NI clutch after the engine is restarted.

8. The controller of claim 7, wherein the controller is adapted to shift the transmission into the NI state during one of: a zero vehicle speed state and a coast-down maneuver of the vehicle from a forward drive mode.

9. The controller of claim 7, wherein the vehicle includes an auxiliary device adapted to maintain a fluid pressure supplied to the transmission when the engine is off, and wherein the controller is adapted for commanding one of a return spring pressure and a zero fill pressure to fill the NI clutch prior to engine restart depending on a configuration of the auxiliary device.

10. The controller of claim 9, wherein the auxiliary device is one of an auxiliary pump and a surge accumulator, and wherein the controller is adapted for commanding the return spring pressure when the auxiliary device is the auxiliary pump, and for commanding the zero fill pressure when the auxiliary device is the surge accumulator.

11. The controller of claim 7, wherein the algorithm includes a first set of conditions for entering the NI state during engine shut down and a second set of calibrated criteria for exiting the NI state upon engine restart.

12. A method for shifting a transmission of a vehicle into a neutral idle (NI) state during an engine shut down and restart event, the transmission having a plurality of clutches that are selectively engageable, alone or in combination with each other, to establish a plurality of forward drive modes, the method comprising:
determining the presence of a commanded engine shut down event using a controller;
actuating a designated one of the clutches as an NI clutch using the controller to thereby enter the NI state prior to shutting down the engine to thereby at least partially unload the engine;
determining the presence of a commanded engine restart event;
starting the engine while the engine remains at least partially unloaded; and
actuating the NI clutch to thereby launch the vehicle.

13. The method of claim 12, including shifting the transmission into the NI state during one of: a zero vehicle speed state and a coast-down maneuver of the vehicle from a forward drive mode.

14. The method of claim 12, further comprising: determining whether the vehicle is equipped with an auxiliary device for temporarily providing pressure to the transmission when the engine is off, and commanding one of a return spring pressure and a zero fill pressure to fill the NI clutch prior to engine restart depending on a configuration of the auxiliary device.

15. The method of claim 12, further comprising: evaluating a set of conditions for exiting the NI state, the set of conditions including one of: passing an engine speed threshold and a predetermined engine run state.

16. The method of claim 12, wherein the vehicle is equipped with a surge accumulator in fluid communication with the plurality of clutches, the method further comprising: commanding a fill pulse from the surge accumulator upon engine restart.
